(19) United States
(12) Patent Application Publication
(10) Pub. No.: US 2026/0249430 A1
(43) Pub. Date: Aug. 27, 2026

(54) WRENCH ENGAGEMENT PROFILE

(71) Applicant: APEX BRANDS, INC., Apex, NC (US)

(72) Inventors: Zhihong FU, Cary, NC (US); Noah Thomas STEEN, Cary, NC (US); Kyle ROMANICK, Fuquay-Varina, NC (US); Jenny APPLETON, Apex, NC (US)

(21) Appl. No.: 19/160,137

(22) PCT Filed: Mar. 1, 2024
(86) PCT No.: PCT/US2024/018063

§ 371 Date: Aug. 27, 2025

Related U.S. Application Data
(60) Provisional application No. 63/449,131, filed on Mar. 1, 2023.

(51) Int. Cl. B25B 13/04; B25B 13/06; B25B 13/08; B25B 13/46; B25B 23/10

(52) U.S. Cl. CPC B25B 13/04; B25B 23/108; B25B 13/065; B25B 13/08; B25B 13/462

(57) ABSTRACT

A tool for driving fasteners may include a box end which may be configured to interface with a fastener, and a lever arm which may be operably coupled to and may extend away from the box end. The box end may interface with the fastener via an engagement orifice. The engagement orifice may include a plurality of instances of a gripping surface that may extend parallel to respective planar surfaces of the fastener to operably couple the engagement orifice with the fastener such that the fastener may be drivable while avoiding contact with corner portions of the fastener that may be disposed at intersections of the planar surfaces. The plurality of instances of the gripping surface may extend from a start point to a gripping point disposed between about 50% and about 85% of a distance between consecutive corner portions along each of the planar surfaces.

### TECHNICAL FIELD

Example embodiments generally relate to hand tools and, more particularly, relate to improvements for a tool configured to remove or drive fastening nuts or other drivable components in either direction.

### BACKGROUND

Wrenches are familiar tools for both fastening and removing nuts, bolts, and other drivable components or fasteners. A common form of wrench may be the combination wrench which may include an open end, a lever arm, and a box end. The open end and the box end may each interface with nuts, bolt heads, or other fasteners. Because high torque is often applied through these tools, and high strength and durability is desirable, wrenches are traditionally made of a metallic material such as iron or steel.

Wrenches are generally made in sets that include a range of sizes that may correspond to each common size of fastener. Often, the open end and the box end of the wrench may be sized for the same size fastener, so that the entire wrench may correspond to one size of fastener. Thus, there may be a wrench for each common size of fastener, that can be used to drive the fastener in either the tightening or loosening direction. In this regard, the shape of either end of the wrench may be matched with the fastening nut or fastener head (e.g., typically hexagonal in shape) to ensure maximum surface contact and therefore even distribution of force to all of the faces of the fastening nut or fastener head. However, it may often be the case that forces from the wrench get concentrated on the corners of the fastening nuts (i.e., the transitions between the adjacent faces that form the familiar hexagonal shape). These concentrated forces can damage or strip the corners of the fastening nut or fastener head so that the corners become rounded. When the corners become sufficiently rounded, traditional wrenches will slip when a significant force is applied or the wrench may even be rendered useless and no longer be able to grip the fastener sufficiently to move it one or both directions. The risk of rounding can be exacerbated when fasteners are exposed to water, harsh chemicals, or other environments that can rust or corrode the fastener nut or head.

Thus, it may be desirable to provide a new design for a wrench with improved performance, including a capability for bi-directionally gripping and driving fasteners, including severely rounded, corroded, or damaged fasteners.

### BRIEF SUMMARY OF SOME EXAMPLES

Some example embodiments may provide for a tool for driving fasteners. The tool may include a box end which may be configured to interface with a fastener, and a lever arm which may be operably coupled to and may extend away from the box end. The box end may interface with the fastener via an engagement orifice. The engagement orifice may include a plurality of instances of a gripping surface that may extend parallel to respective planar surfaces of the fastener to operably couple the engagement orifice with the fastener such that the fastener may be drivable while avoiding contact with corner portions of the fastener that may be disposed at intersections of the planar surfaces. The plurality of instances of the gripping surface may extend from a start point to a gripping point disposed between about 50% and about 85% of a distance between consecutive corner portions along each of the planar surfaces.

In another example embodiment, an engagement orifice for a tool to interface with and drive a fastener may be provided. The engagement orifice may include a plurality of instances of a gripping surface that may extend parallel to respective planar surfaces of the fastener to operably couple the engagement orifice with the fastener such that the fastener may be drivable while avoiding contact with corner portions of the fastener that may be disposed at intersections of the planar surfaces. The plurality of instances of the gripping surface may extend from a start point to a gripping point disposed between about 50% and about 85% of a distance between consecutive corner portions along each of the planar surfaces.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a hand tool according to an example embodiment;

FIG. 2 illustrates a full side profile view of the hand tool according to an example embodiment;

FIG. 3 illustrates a close up side profile view of the box end of the hand tool, taken from box 3 in FIG. 2, according to an example embodiment;

FIG. 4 illustrates a close up side profile view of the box end of the hand tool, taken from box 4 in FIG. 3, according to an example embodiment; and

FIG. 5 illustrates a close up perspective view of the box end of the hand tool according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

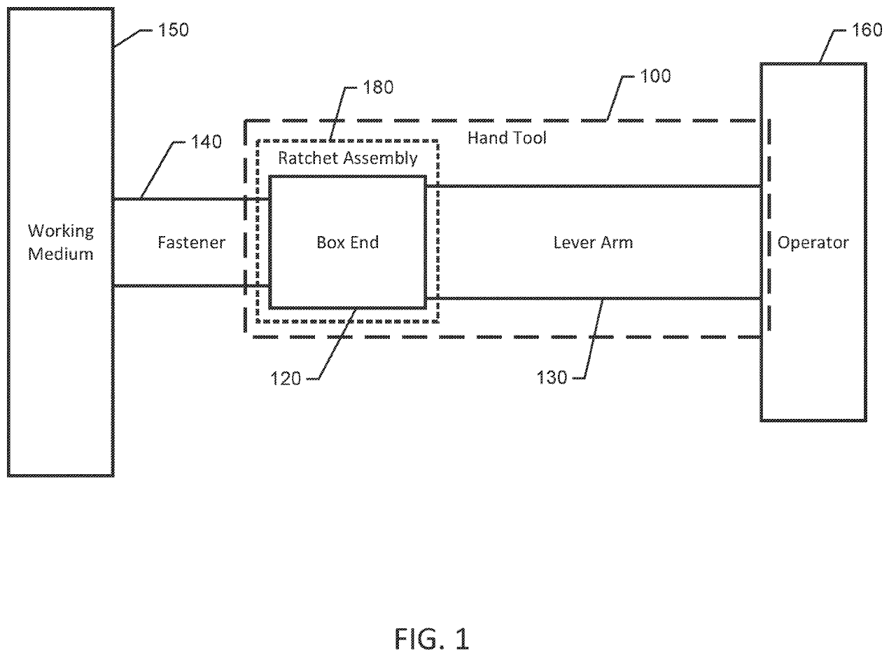

As indicated above, some example embodiments may relate to the provision of a hand tool 100 with an improved design for interfacing with fasteners. Of note, in some embodiments, the hand tool 100 of FIG. 1 may be a combination wrench. The combination wrench may thus include an open end, and a box end, operably coupled to one another by a lever arm. While the improvements described herein may be described in reference to the box end of a combination wrench, it should be appreciated that the improvements may be applied to other portions of the hand tool, such as the open end, and to other types of hand tools. In this regard, in an example embodiment the hand tool may be a socket or ratchet wrench. As such, the box end of the hand tool may be operably coupled to the lever arm via a ratchet assembly. In some cases, the box end may be removably operably coupled to the hand tool.

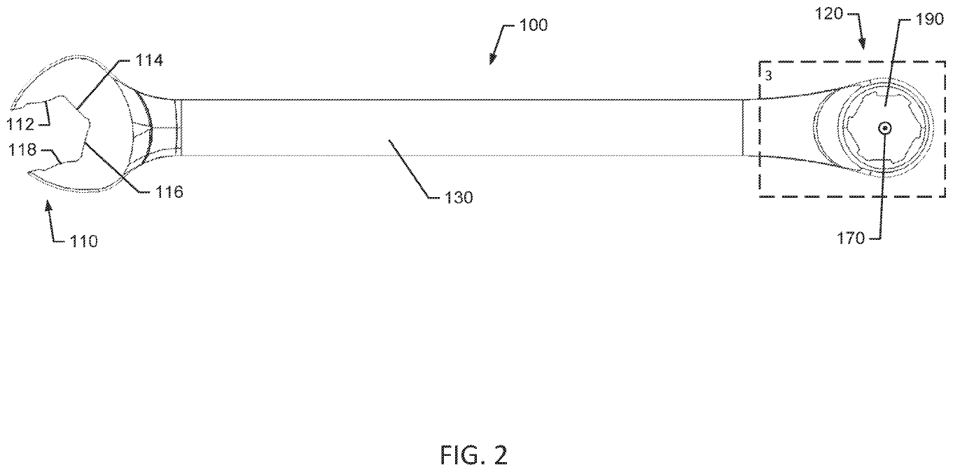

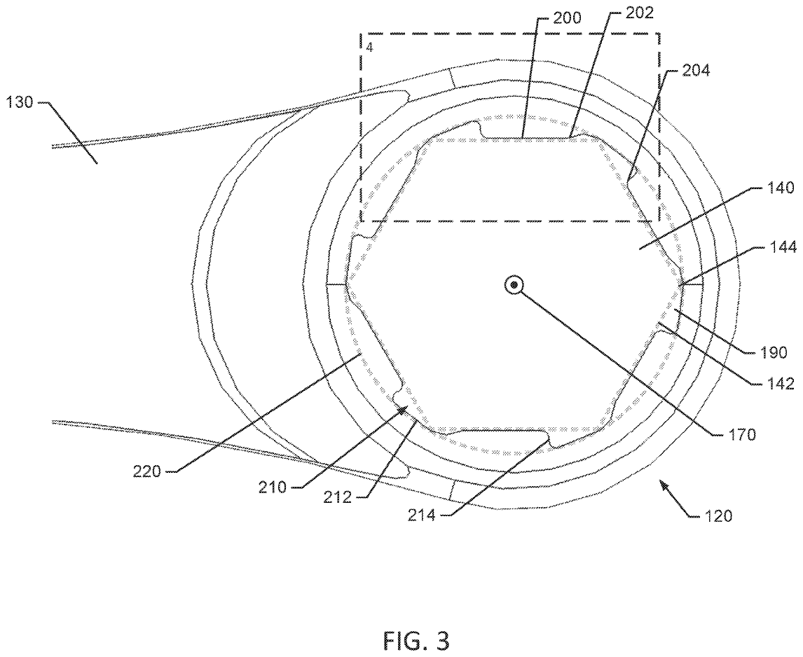

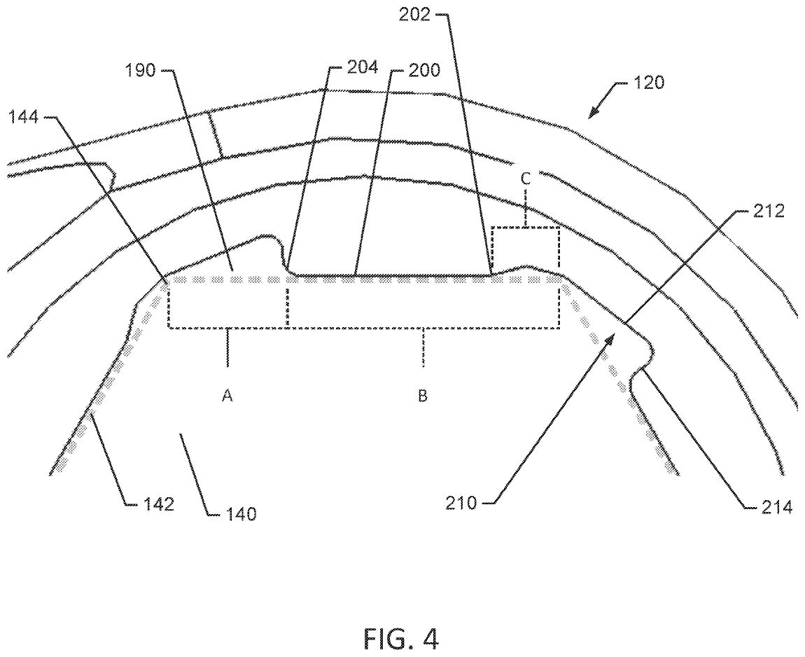

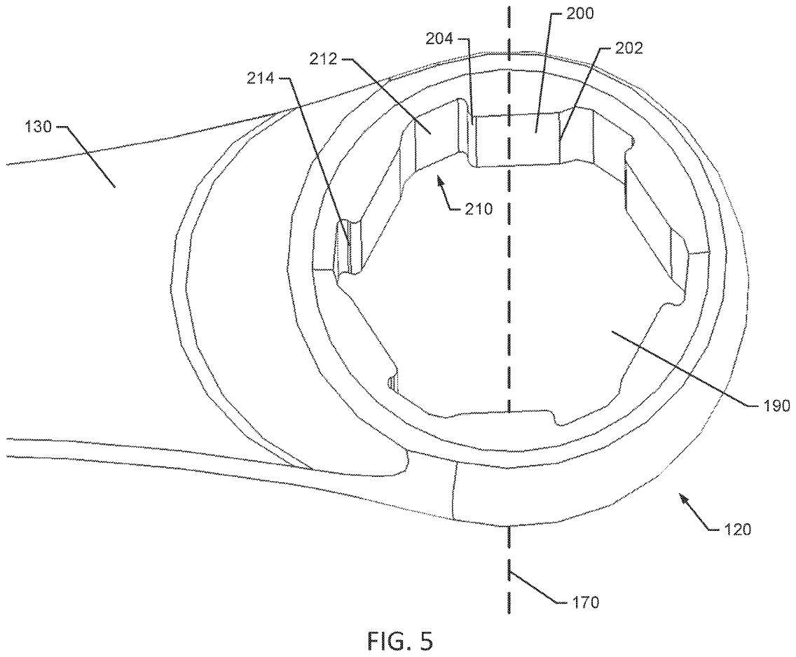

FIG. 1 illustrates a block diagram of a hand tool 100 that may be configured to drive fasteners (including damaged fasteners). According to some embodiments, the hand tool 100 may be a wrench, a combination wrench, a socket wrench, or another similar tool for driving fasteners. FIG. 2 illustrates a side profile view of the full hand tool 100 to illustrate an open end 110 and a box end 120 of the hand tool 100. FIG. 3 illustrates a close up side profile view of the box end 120 of the hand tool 100 taken from box 3 in FIG. 2, in accordance with an example embodiment. FIG. 4 illustrates a close up side profile view of the box end 120 of the hand tool 100 taken from box 4 in FIG. 3, in accordance with an example embodiment. FIG. 5 illustrates a close up perspective view of the box end 120 of the hand tool 100 according to an example embodiment.

Referring to FIG. 1, the hand tool 100 may at least include a box end 120 and a lever arm 130. The box end 120 may be configured to operably couple the hand tool 100 to a fastener 140 (e.g., a fastening nut such as a hex nut, a fastening head such as a hex head on a bolt or screw, or other fastener driven by a force applied to the periphery of the fastener nut or fastener head) in order for the hand tool 100 to be able to drive the fastener 140 relative to a working medium 150. In this regard, the working medium 150 may be any material or object that may be capable of operably coupling to the fastener 140 in some manner. In some embodiments, the lever arm 130 may be operably coupled to the box end 120 and may extend away from both the box end 120 and the fastener 140. In this regard, to drive the fastener 140, an operator 160 may apply a force to the lever arm 130 at a distal end of the lever arm 130 such that the hand tool 100 may impart a driving force (i.e. a moment force) on the fastener 140 via the box end 120, which may cause the fastener 140 to rotate about an axis of rotation 170 relative to the working medium 150.

In an example embodiment, the lever arm 130 may be rigidly operably coupled to the box end 120. As such, the box end 120 may be formed from the same material as the lever arm 130, and may be integrated into an end of the lever arm 130 accordingly. In such cases, the hand tool 100 and the fastener 140 may rotate at a 1:1 ratio. For example, in order to rotate the fastener 140 for one full rotation (i.e. 360°), then the hand tool 100 may also rotate for one full rotation while driving the fastener 140. If the hand tool 100 encounters anything that may inhibit the rotation of the hand tool 100, then the box end 120 may be removed from the fastener 140, the hand tool 100 may be repositioned so it may be free to rotate yet again, the box end 120 may be re-operably coupled to the fastener 140, and the driving of the fastener 140 may resume. In some cases, the lever arm 130 may be operably coupled to the box end 120 via a ratchet assembly 180. In this regard, the operator 160 may continue to rotate the hand tool 100 at a 1:1 ratio with the fastener 140, but may no longer need to remove the box end 120 from the fastener 140 in order to reposition the hand tool 100. In other words, the lever arm 130 may oscillate back and forth within a range of angular orientations (e.g. within a 50° sector) in order to drive the fastener 140 relative to the working medium 150. As such, due to the ratchet assembly 180, the box end 120 may transfer the driving force to the fastener 140 responsive to the hand tool 100 moving in a first direction (e.g. clockwise), however the box end 120 may not transfer the driving force to the fastener 140 responsive to the hand tool 100 moving in a second direction (e.g. counterclockwise) that may oppose the first direction. In such cases, the operation of the hand tool 100 may be similar to that of a ratchet wrench or a socket wrench. According to an example embodiment, the hand tool 100 may also include an open end 110 disposed at a distal end of the lever arm 130 from the box end 120. Thus in some embodiments, the hand tool 100 may be a combination wrench.

FIG. 2 illustrates a side profile view of the full hand tool 100 including the open end 110 and the box end 120, according to an example embodiment. The open end 110, similar to the box end 120, may operably couple to a fastener 140 in order to drive the fastener 140 relative to a working medium 150. The open end 110, however, may be open (i.e. not enclosed) to allow the fastener 140 to enter and exit the open end 110 accordingly. In other words, the profile of the open end 110 may not be a closed polygon, unlike the profile of the box end 120. As such, the open end 110 may include first, second, third and fourth engagement surfaces (112, 114, 116, 118) within the open end 110 that may each interface with respective planar surfaces 142 disposed at the fastener 140. As such, the fastener 140 may lie in a plane also containing the hand tool 100, and the fastener 140 may enter the open end 110 without either of the hand tool 100 or the fastener 140 leaving said plane. The first and fourth engagement surfaces (112, 118) of the open end 110 may be parallel to one another, and may be configured to interface with respective planar surfaces 142 on the fastener 140 that may also be parallel to each other. Thus, a distance measured between the first and fourth engagement surfaces (112, 118) may be substantially equal to a width of the fastener 140 measured between a pair of parallel planar surfaces 142.

In contrast to the open end 110, the box end 120 may be enclosed on all sides and may perhaps bear some resemblance to a ring in that material may be disposed in a substantially circular manner surrounding an orifice disposed at the center. Thus, in order for the fastener 140 to enter the box end 120 of the hand tool 100, either the fastener 140 or the hand tool 100 must momentarily leave the plane containing the other of the fastener 140 or the hand tool 100 so that the fastener 140 may be enclosed within, and operably coupled to, the box end 120. In the embodiment depicted in FIG. 2, the hand tool 100 may be a combination wrench. In some other cases, as discussed above in reference to FIG. 1, the hand tool 100 may be a socket wrench. In such cases, the box end 120 may be operably coupled to the lever arm 130 via the ratchet assembly 180, and the distal end of the lever arm 130 may not include the open end 110. Typically, the size of the lever arm 130 may be selected based on a size of the fastener 140 that the hand tool 100 is designed to work with. In this regard, for example, if the hand tool 100 is designed to work with a ½ inch fastener 140, the size of the lever arm 130 may be selected to be at least large enough to operably couple to the ½ inch sized box end 120 plus sufficient additional support material to allow large amounts of torque to be applied to the fastener 140 via the hand tool 100. In some cases, the hand tool 100 may be made from a metallic materials such as an iron alloy or a steel alloy.

FIG. 3 illustrates a close up side profile view of the box end 120 of the hand tool 100 taken from box 3 in FIG. 2, in accordance with an example embodiment. As stated above, the box end 120 may be the end of the hand tool 100 that interfaces with a fastener 140 to drive the fastener 140 responsive to the driving force provided by the hand tool 100. As a result of the enclosed, ring-like structure of the box end 120, the box end 120 may include an engagement orifice 190 that may interface with the fastener 140 via the respective planar surfaces 142 disposed at the fastener 140. In this regard, the box end 120 may be shaped as a substantially circular end that may be operably coupled to an end of the lever arm 130. The engagement orifice 190 may therefore transfer the driving force from the hand tool 100 to the fastener 140 to allow the hand tool 100 to drive the fastener 140.

As shown in FIG. 3, the engagement orifice 190 may include a plurality of instances of a gripping surface 200 that may extend parallel to, and interface with, respective ones of the planar surfaces 142 of the fastener 140 to operably couple the engagement orifice 190 with the fastener 140. In some embodiments, the engagement orifice 190 may include one gripping surface 200 for each planar surface 142 disposed at the fastener 140. As such, the fastener 140 may contact the engagement orifice 190 at the plurality of instances of the gripping surface 200, and thus may be operably coupled to the engagement orifice 190 via the same. The engagement orifice 190 may also include corner relief zones 210 that may be disposed between consecutive instances of the gripping surface 200. In this regard, the fastener 140 may be drivable via the gripping surfaces 200 while reducing the concentration of forces at corner portions 144 of the fastener 140, which may be disposed at intersections of consecutive planar surfaces 142.

The corner relief zones 210 may include a first surface 212 that may define an outer bound of the corner relief zone 210 and a second surface 214 that may extend from the first surface 212 to a gripping point 204. In some cases, the first surface 212 of the corner relief zone 210 may define an outermost bound of the entire engagement orifice 190. In the embodiment depicted in FIG. 3, the first surface 212 of each of the corner relief zones 210 may be disposed along a circle 220 drawn to connect each corner portion 144 of the fastener 140 and may be centered around the axis of rotation 170. In this regard, the size of the fastener 140 that the hand tool 100 is intended to operably couple with may determine the size of the engagement orifice 190 accordingly. As such, the first surface 212 of each corner relief zone 210 may be arcuate, which may reduce the concentration of the driving force disposed at the corner portions 144 while driving the fastener 140.

In the embodiment of FIG. 3, the second surface 214 may be disposed perpendicular to respective ones of the planar surface 142 of the fastener 140. However in some other cases, the second surface 214 may be arcuate, and in such cases, the second surface 214 may not be disposed perpendicularly to the planar surface 142. In this regard, the second surface 214 may intersect with the plurality of instances of the gripping surface 200 to form the gripping point 204. The gripping point 204 may concentrate the driving force from the hand tool 100 at the gripping point 204, and deliver the driving force to the fastener 140 accordingly. Since the gripping point 204 of each of the plurality of instances of the gripping surface 200 may be where the driving force concentrates in the engagement orifice 190, rather than be a sharp corner formed at a right angle, the gripping point 204 may be a fillet with a radius approximately between 2% to 10% of the width of the fastener 140 as measured perpendicularly between parallel planar surfaces 142 of the fastener 140. In some cases, the radius of the fillet may even be between 2.5% to 3% of the width of the fastener 140 measured perpendicularly between parallel planar surfaces 142. In other words, the gripping point 204 may be formed at a corner of the gripping surface 200 and the second surface 214. The rounding of said corner to include a radius of curvature rather than be a sharp 90° angle, may be referred to as a fillet. Thus, the gripping point 204 may be a fillet, and may have a radius approximately between 2% to 10% of the width of the fastener 140 as measured perpendicularly between parallel planar surfaces 142 of the fastener 140. The fillet may be an important part of the engagement orifice 190 because it may reduce the amount of marring on the fastener 140 that may result from being driven by the hand tool 100. The gripping point 204 may therefore deliver the driving force to the fastener 140 using a rounded edge to grasp the fastener 140, which may do a better job at preserving the fastener 140 than a gripping point 204 that may be a sharp corner. Additionally, the fillet at the gripping point 204 may serve to preserve the gripping point 204 as well. In this regard, the engagement orifice 190 may be less likely to wear down after numerous repeated use cases and the hand tool 100 may accordingly maintain its effectiveness over a longer period of time. As such, the range of 2% to 10% of the width of the fastener 140 as measured perpendicularly between parallel planar surfaces 142 may be critical to the operation of the engagement orifice 190. In this regard, the gripping point 204 may provide an ideal radius so that there is enough traction to transfer the driving force to the fastener 140 without being too sharp to damage the fastener 140 or the engagement orifice 190 in the process. In some cases, the gripping point 204 may allow the hand tool 100 to drive fasteners 140 that may already be stripped and/or marred to some extent. Table 1 below includes the radius (R) of the gripping point 204 that may correspond to common fastener 140 sizes.

TABLE 1
Gripping Point Radii for Common Fastener Sizes

| Fastener size | Radius (R) (mm) |
|---|---|
| 8 mm | 0.20 |
| 9 mm | 0.25 |
| 10 mm | 0.25 |
| 11 mm | 0.30 |
| 12 mm | 0.30 |
| 13 mm | 0.35 |
| 14 mm | 0.35 |
| 15 mm | 0.40 |
| 17 mm | 0.45 |
| 19 mm | 0.50 |
| ¼″ | 0.20 |
| 5/16″ | 0.20 |
| ⅜″ | 0.25 |
| 7/16″ | 0.30 |
| ½″ | 0.35 |
| 9/16″ | 0.35 |
| ⅝″ | 0.40 |
| 11/16″ | 0.45 |
| ¾″ | 0.50 |
| ⅞″ | 0.60 |

FIG. 4 illustrates a close up side profile view of the box end 120 of the hand tool 100 taken from box 4 in FIG. 3, in accordance with an example embodiment. As shown in FIG. 4, each instance of the plurality of instances of the gripping surface 200 may extend from a start point 202 to the gripping point 204. The start point 202 may be proximate to the corner relief zone 210, and may define the boundary between the corner relief zone 210 and the gripping surface 200. The corner relief zone 210 may in fact be defined by the start point 202 of a first gripping surface 200 to the gripping point 204 of a separate consecutive gripping surface 200. The respective positions of the start point 202 and the gripping point 204, as well as the length of the gripping surface 200, may all be described relative to the fastener 140 and the planar surfaces 142 disposed at the fastener 140. In this regard, FIG. 4 depicts different delineated segments of the planar surface 142 labeled as A, B and C. For instance, in some cases, the plurality of instances of the gripping surface 200 may extend from the start point 202 to the gripping point 204 which may be disposed between 50% and 85% of a distance between consecutive corner portions 144 along each of the planar surfaces 142. In other words, the length of segment B in FIG. 4 may be between 50% and 85% of the length of segments A+B. In an example embodiment, the gripping point 204 may be disposed 70% of a distance between consecutive corner portions 144. In this regard, segment B may be approximately equal to 70% of the length of A+B and thus A may be approximately equal to 30% of the length of A+B.

The 30-70 ratio of segment A to segment B may be critical to the effective operation of the hand tool 100. In other words, with the gripping point 204 disposed at 70% of a distance between consecutive corner portions 144 along each of the planar surfaces 142 the engagement orifice 190 may minimize marring of the fastener 140 as a result of driving the fastener 140, and may maximize the amount of driving force transferred to the fastener 140. As a result, the hand tool 100 may be easier and more efficient for the operator 160 to operate, as well as safer on the fastener 140.

Segment C in FIG. 4 may refer to the distance from the corner portion 144 at which the start point 202 may be disposed. Accordingly, the plurality of instances of the gripping surface 200 may begin at the start point 202 that may be disposed between 0% and 30% of a distance between consecutive corner portions 144 along each of the planar surfaces 142. In other words, segment C in FIG. 4 may be approximately equal to between 0% and 30% of the length of A+B. In this regard, the corner portion 144 may be disposed in the corner relief zone 210 responsive to the fastener 140 operably coupling to the engagement orifice 190. The start point 202 being disposed between 0% to 30% of the length of the planar surface 142 may be critical to the operation of the fastener 140 and to preventing the driving force from concentrating at the corner portions 144.

FIG. 5 illustrates a close up perspective view of the box end 120 of the hand tool 100 according to an example embodiment. In the perspective view of FIG. 5, other dimensions of the engagement orifice 190 may be more apparent. In some cases, the depth of the engagement orifice 190 may be approximately equal to the depth of a head of the fastener 140. In some cases, the engagement orifice 190 may include a taper towards the axis of rotation 170 extending through the box end 120. In other words, if the engagement orifice 190 orifice included a first plane disposed at a top of the box end 120 and a second plane disposed at a bottom of the box end 120 and parallel to the first plane, then the profile (i.e. cross section) of the engagement orifice 190 at the first plane may be greater than the profile (i.e. cross section) of the engagement orifice 190 at the second plane if the engagement orifice 190 included a taper. As such, the engagement orifice 190 may self-tighten onto the fastener 140 if the engagement orifice 190 was tapered by operably coupling to the fastener 140 at the wider (i.e. larger) end of the engagement orifice 190. However, in an example embodiment, the engagement orifice 190 may extend parallel with an axis of rotation 170 extending through the box end 120, or in other words, the engagement orifice 190 may not include a taper. In some cases, the hand tool 100 may be bi-directional. In this regard, the engagement orifice 190 may impart a driving force on the fastener 140 to either loosen the fastener 140 or tighten the fastener 140. In an example embodiment, the hand tool 100 is only mono-directional and separate hand tools 100 may be needed to loosen and tighten the fastener 140.

Some example embodiments may provide for a tool for driving fasteners. The tool may include a box end which may be configured to interface with a fastener, and a lever arm which may be operably coupled to and may extend away from the box end. The box end may interface with the fastener via an engagement orifice. The engagement orifice may include a plurality of instances of a gripping surface that may extend parallel to respective planar surfaces of the fastener to operably couple the engagement orifice with the fastener such that the fastener may be drivable while avoiding contact with corner portions of the fastener that may be disposed at intersections of the planar surfaces. The plurality of instances of the gripping surface may extend from a start point to a gripping point disposed between about 50% and about 85% of a distance between consecutive corner portions along each of the planar surfaces.

The tool of some embodiments may include additional features, modifications, augmentations and/or the like to achieve further objectives or enhance performance of the tool. The additional features, modifications, augmentations and/or the like may be added in any combination with each other. Below is a list of various additional features, modifications, and augmentations that can each be added individually or in any combination with each other. For example, the gripping point may be a fillet with a radius approximately between about 2% to about 10% of a width of the fastener measured perpendicularly between parallel planar surfaces of the fastener. In some cases, the engagement orifice may further include a corner relief zone that may be disposed between consecutive instances of the gripping surface. In an example embodiment, the corner relief zone may include a first surface that may define an outer bound of the corner relief zone and a second surface that may extend from the first surface to the gripping point. In some cases, the first surface of the corner relief zone may be disposed along a circle that may be drawn to connect each corner portion of the fastener. In an example embodiment, the second surface may be disposed perpendicular to the respective planar surfaces of the fastener. In some cases, the second surface may be arcuate. In an example embodiment, the plurality of instances of the gripping surface may begin at the start point disposed between about 0% and about 30% of a distance between consecutive corner portions along each of the planar surfaces. In some cases, the gripping point may be disposed about 70% of a distance between consecutive corner portions along each of the planar surfaces. In an example embodiment, the engagement orifice may be tapered towards an axis of rotation that may extend through the box end to operably couple with the fastener. In some cases, the engagement orifice may be parallel with an axis of rotation that may extend through the box end to operably couple with the fastener. In an example embodiment, the box end may be operably coupled to the lever arm by a ratchet assembly. In some cases, the tool may be a combination wrench.

Some example embodiments may provide for an engagement orifice for a tool to interface with and drive a fastener. The engagement orifice may include a plurality of instances of a gripping surface that may extend parallel to respective planar surfaces of the fastener to operably couple the engagement orifice with the fastener such that the fastener may be drivable while avoiding contact with corner portions of the fastener that may be disposed at intersections of the planar surfaces. The plurality of instances of the gripping surface may extend from a start point to a gripping point disposed between about 50% and about 85% of a distance between consecutive corner portions along each of the planar surfaces.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A tool for driving fasteners, the tool comprising:
a box end configured to interface with a fastener; and
a lever arm operably coupled to and extending away from the box end,
wherein the box end interfaces with the fastener via an engagement orifice,
wherein the engagement orifice comprises a plurality of instances of a gripping surface that extend parallel to respective planar surfaces of the fastener to operably couple the engagement orifice with the fastener such that the fastener is drivable while avoiding contact with corner portions of the fastener disposed at intersections of the planar surfaces, and
wherein the plurality of instances of the gripping surface extend from a start point to a gripping point disposed between about 50% and about 85% of a distance between consecutive corner portions along each of the planar surfaces.

2. The tool of claim 1, wherein the gripping point is a fillet with a radius approximately between about 2% to about 10% of a width of the fastener measured perpendicularly between corresponding parallel planar surfaces of the fastener.

3. The tool of claim 1, wherein the engagement orifice further comprises a corner relief zone disposed between consecutive instances of the gripping surface,
wherein the corner relief zone comprises a first surface defining an outer bound of the corner relief zone and a second surface that extends from the first surface to the gripping point.

4. The tool of claim 3, wherein the first surface of the corner relief zone is disposed along a circle drawn to connect each corner portion of the fastener.

5. The tool of claim 3, wherein the second surface is disposed perpendicular to the respective planar surfaces of the fastener.

6. The tool of claim 3, wherein the second surface is arcuate.

7. The tool of claim 1, wherein the plurality of instances of the gripping surface begin at the start point disposed between about 0% and about 30% of a distance between consecutive corner portions along each of the planar surfaces.

8. The tool of claim 1, wherein the gripping point is disposed about 70% of a distance between consecutive corner portions along each of the planar surfaces.

9. The tool of claim 1, wherein the engagement orifice is tapered towards an axis of rotation extending through the box end to operably couple with the fastener.

10. The tool of claim 1, wherein the engagement orifice is parallel with an axis of rotation extending through the box end to operably couple with the fastener.

11. The tool of claim 1, wherein the box end is operably coupled to the lever arm by a ratchet assembly.

12. An engagement orifice for a tool to interface with and drive a fastener, the engagement orifice comprising a plurality of instances of a gripping surface that extend parallel to respective planar surfaces of the fastener to operably couple the engagement orifice with the fastener such that the fastener is drivable while avoiding contact with corner portions of the fastener disposed at intersections of the planar surfaces, and
wherein the plurality of instances of the gripping surface extend from a start point to a gripping point disposed between about 50% and about 85% of a distance between consecutive corner portions along each of the planar surfaces.

13. The engagement orifice of claim 12, wherein the gripping point is a fillet with a radius between about 2% to about 10% of a width of the fastener measured perpendicularly between corresponding parallel planar surfaces of the fastener.

14. The engagement orifice of claim 12, wherein the engagement orifice further comprises a corner relief zone disposed between consecutive instances of the gripping surface,
wherein the corner relief zone comprises a first surface defining an outer bound of the corner relief zone and a second surface that extends from the first surface to the gripping point.

15. The engagement orifice of claim 14, wherein the first surface of the corner relief zone is disposed along a circle drawn to connect each corner portion of the fastener.

16. The engagement orifice of claim 14, wherein the second surface is disposed perpendicular to the respective planar surfaces of the fastener.

17. The engagement orifice of claim 14, wherein the second surface is arcuate.

18. The engagement orifice of claim 12, wherein the plurality of instances of the gripping surface begin at the start point disposed between about 0% and about 30% of a distance between consecutive corner portions along each of the planar surfaces.

19. The engagement orifice of claim 12, wherein the gripping point is disposed about 70% of a distance between consecutive corner portions along each of the planar surfaces.

20. The engagement orifice of claim 12, wherein the engagement orifice is disposed within a box end of a combination wrench.
